(19) United States
(12) Patent Application Publication
(10) Pub. No.: US 2009/0021214 A1
(43) Pub. Date: Jan. 22, 2009

(54) Portable electronic device carrier with charging system

(76) Inventors: David A. Foster, Orange City, FL (US); Arturo E. Bendek, JR., Miami, FL (US)

Correspondence Address: WEIDE & MILLER, LTD., 7251 W. LAKE MEAD BLVD., SUITE 530, LAS VEGAS, NV, 89128, US

(21) Appl. No.: 11/880,184

(22) Filed: Jul. 19, 2007

(51) Int. Cl. H02J 7/00; H01M 10/44

(52) U.S. Cl. 320/114; 320/101; 320/103

(57) ABSTRACT

A portable electronic device carrier includes a charging system. The carrier is configured to at least partially house a portable electronic device such as a cell phone, PDA or the like. The carrier may comprise a pouch or have other configurations. The charging system comprises at least one photovoltaic cell configured to convert light into electricity, and at least one charging port configured to be engaged by a portable electronic device, the charging port configured to provide power to the portable electronic device when the portable electronic device is engaged therewith. The charging system may include at least one battery configured to be charged by the electricity generated by the at least one photovoltaic cell. The charging port may comprise contacts which are engaged by an interface of the portable electronic device. In accordance with the invention, a portable electronic device is charged using a portable charging system associated with a carrier for the device.

### FIELD OF THE INVENTION

The present invention relates to electric chargers for portable electronic devices such as cell phones and PDAs.

### BACKGROUND OF THE INVENTION

Cell phones, PDAs and other portable electronic devices are extremely prevalent. People are increasingly relying upon these devices for a range of purposes. For example, while cell phones were originally most commonly used by business travelers, they are now more widely used. For example, teens may carry cell phones in order to communicate with their parents in the event of an emergency, to communicate with their friends at school, or at home without tying up a home phone land line. In some cases, people are using their cell phone in replacement of their land lines. Similarly, PDAs have grown in popularity, owing to the range of functions they now provide.

One problem with these devices is, being portable, they are powered by a battery that requires frequent charging. Often, a user may find that their cell phone is not fully charged, and they may lose power during use. Loss of battery power to a PDA or cell phone can even result in loss of stored information.

Generally, these devices are charged by connecting them to a power source via a charging cable. Most commonly, these devices are provided with a “home” charging cable which allows the device to be charged via a 110V AC power source, such as the type commonly found in the home at a wall outlet. The device may also be provided with a “car” charger which allows the device to be charged via a 12V DC power source, such as the type commonly found in an automobile.

However, the device owner may forget their charger. For example, a traveler may forget to bring their home or car charger with them and arrive at a remote destination with no way to charge their device. Similarly, even if one charges their cell phone or PDA at home during the evening, the battery power may be depleted the next day when the device is used at school, at work or at another remote location. The user may then not be able to charge the device until they return home that evening.

One solution to this problem is to obtain an additional or backup battery. This battery may be charged at the same time as the main device battery and be transported with the device. If the main battery loses its charge, the second battery may be placed in the device. This, however, is a cumbersome solution to the problem. The solution requires one to purchase an expensive battery and keep that battery, like the battery in the main device, charged up. If one travels for a few days, the charge in both batteries may quickly be depleted, leaving the user without use of their device once again.

### SUMMARY OF THE INVENTION

A portable electronic device carrier includes a charging system. The carrier is configured to at least partially house a portable electronic device such as a cell phone, PDA or the like. The carrier may comprise a pouch or have other configurations.

The charging system comprises at least one photovoltaic cell configured to convert light into electricity, and at least one charging port configured to be engaged by a portable electronic device. The charging port is configured to provide power to the portable electronic device when the portable electronic device is engaged therewith.

In other embodiments of the invention, the charging system may include at least one battery configured to be charged by the electricity generated by the at least one photovoltaic cell. The charging system may also include features such as one or more controllers and an indicator providing an indication that charging of the device is occurring.

In one embodiment, the charging port is configured to be engaged with the portable electronic device when the device is placed in the carrier. For example, the charging port may comprise contacts which extend along an interior of the carrier for engagement by the interface of the device when it is placed in the carrier. The charging port may alternatively be configured to charge the device inductively (i.e. without direct contact).

In accordance with the invention, a portable electronic device is charged using a portable charging system associated with a carrier for the device.

Further objects, features, and advantages of the present invention over the prior art will become apparent from the detailed description of the drawings which follows, when considered with the attached figures.

### DESCRIPTION OF THE DRAWINGS

FIG. 1 is an external perspective view of a portable electronic device carrier a charging system in accordance with one embodiment of the invention;

FIG. 2 is a perspective view of the portable electronic device carrier illustrated in FIG. 1 with a flap thereof in an open position, exposing an interior of the carrier;

FIG. 3 is a top view of another embodiment portable electronic device carrier; and

FIG. 4 schematically illustrates a charging system configuration in accordance with an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a carrier for a portable electronic device, the carrier having a charging system. In one embodiment, the charging system includes a power source in the form of a solar or photovoltaic unit.

As used herein, the term “portable electronic device” (or PED) may comprise any of a variety of devices now know or later developed which include their own limited power supply, such as a re-chargeable battery, which power supply must be re-charged from an external source. Such devices may comprise, but are not limited to cell phones, PDAs, music players, GPS units, laptop and other computers, and other devices.

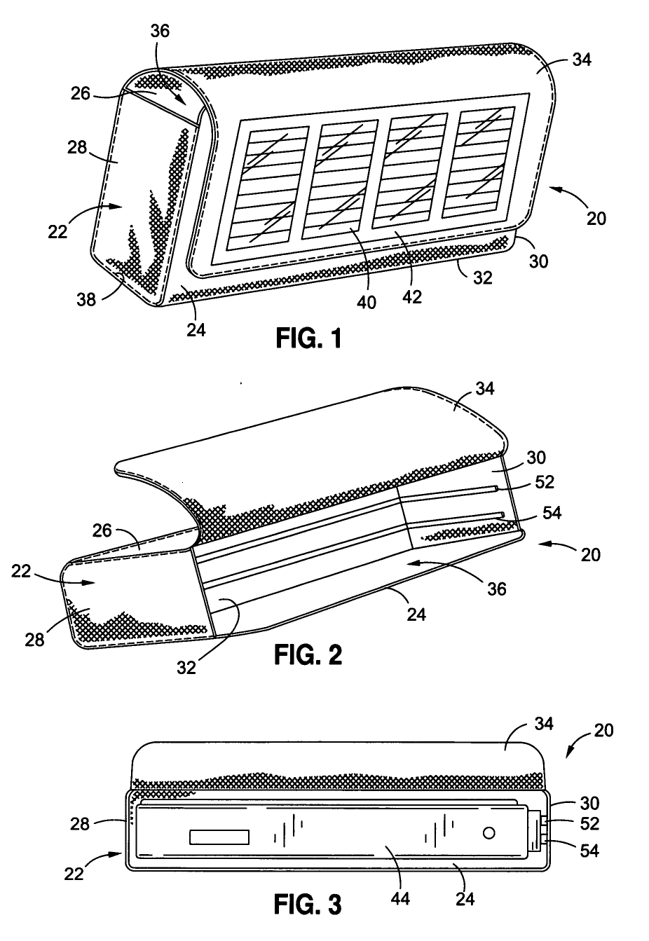

FIG. 1 illustrates a PED carrier 20 in accordance with one embodiment of the invention. The carrier 20 may have a variety of shapes, sizes and features, such as depending upon the one or more PEDs it is intended to be used with. In general, the carrier 20 is preferably configured house or contain at least a portion of a PED, such as for storage or transport.

FIGS. 1-3 illustrates a carrier 20 particularly suited for use in housing a cell phone. In this configuration, the carrier 20 has the form of a pouch configured to contain a cell phone. As illustrated, the carrier 20 has a body 22 having a front 24, a rear 26, a first end 28, a second end 30, a bottom 32, and a flap 34 which serves as a top. The front 24, rear 26, first end 28, second end 30 and bottom 32 preferably define a generally rectangular enclosure having an interior area 36. Each of the front 24, rear 26 first end 28 and second end 30 have a bottom portion which is connected to the bottom 32. A top end of the front 24, first end 28, and second end 30 extend to an otherwise open top. This open top may be selectively covered by the flap 34. As illustrated, the flap 34 is integral with the rear 26 of the carrier 20.

As illustrated in FIG. 1, the flap 34 may be folded upwardly and/or backwardly to open the body 22, providing access to the interior area 36. Alternatively, the flap 34 may be folded over forwardly and/or downwardly to the position illustrated in FIG. 1. At that time, the flap 34 generally closes the top of the interior area 36, the flap 34 extending over a front portion of the front 24 of the body 22.

In one embodiment, the body 22 may be constructed from a fabric material or a reinforced fabric material. The body 22 may be constructed of a wide range of materials, however. In one embodiment, various portions of the body 22 may be constructed as discrete panels, which panels are connected by stitching 38.

In one embodiment of the invention, the carrier 20 includes a charging system. The charging system is configured to provide power to a PED, preferably for charging a power supply, such as a rechargeable battery, thereof. As indicated below, the charging system may comprise an electrical circuit and various components.

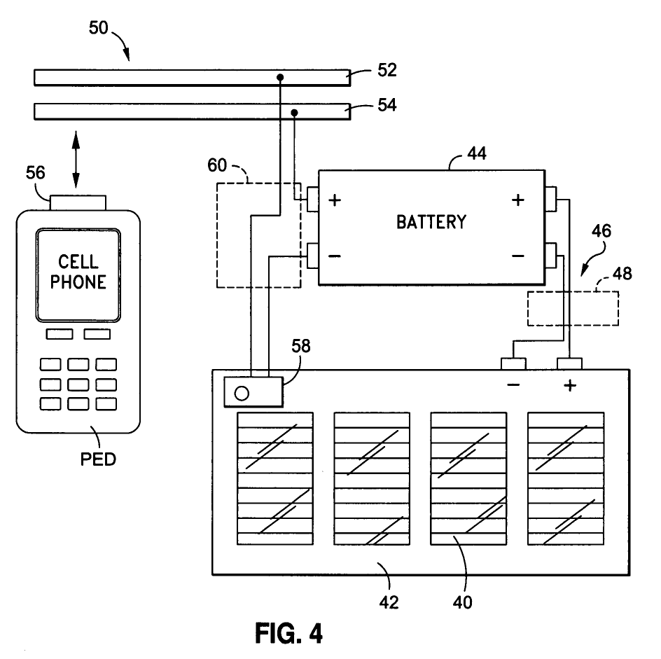

Referring to FIG. 4, the charging system includes a power source. This power source is preferably configured for use in charging a power source of a PED. In one embodiment, the power source is portable, meaning that it is configured to generate or provide power without connection to an external power source. In a preferred embodiment, the power source comprises one or more photovoltaic or solar cells 40. Such cells 40 may have a variety of configurations now known or later developed. Preferably, however, such cells 40 are configured convert light, such as solar energy, into electricity. In one embodiment, the carrier 20 may include a module or unit of two or more cells 40. For example, the carrier 20 is illustrated as including a panel 42 which includes four cells 40.

Preferably, the power source is associated with the carrier 20 so as to be transported therewith. In the embodiment where the power source comprises one or more photovoltaic cells 40, the cells 40 are preferably associated with an exterior portion of the carrier 20, whereby the cells 40 will be exposed to light. For example, in the embodiment illustrated in FIG. 1, the carrier 20 is configured to be mounted on a belt, and may thus include a mount (not shown) at the rear thereof. In that embodiment, the front of the flap 34 generally faces outwardly from the wearer of the carrier, towards light. Thus, in one embodiment, the cells 40 are located on a front portion of the flap 34. Of course, the cell(s) 40 may be located at other portions of the carrier 20 to accomplish the desired purpose. In one embodiment, cells 40 may be located at more than one portion of the carrier 20 (such as both the front and rear, the top and sides or the like). In this manner, the cells may be exposed to light from a variety of positions or directions.

The one or more cells 40 are preferably mounted to the carrier 20. The cell(s) 40 may be removably connected (such as with hook and loop fastener) or be permanently connected (such as with adhesive, by sewing, by trapping edge portions of the panel between layers of the body 22 of the carrier 20 or the like).

In one embodiment, the charging system includes a battery 44. The one or more solar or photovoltaic cells 40 (as illustrated, four cells 40 common to the panel 42) are configured to generate electricity or power when exposed to light. In a preferred embodiment, this power is used to charge the battery 44. Power may be supplied to the battery 44 by appropriate conductors 46, such as wire leads.

In a preferred embodiment, the battery 44 is associated with the carrier 20, such as by being mounted thereto. For example, the battery 44 may be mounted to or be mounted within the body 22 of the carrier 20. Preferably, the battery 44 is relatively small and lightweight and is configured to be rechargeable.

In one embodiment, a controller 48 may be utilized to control the flow of electricity to the battery 44, thus controlling the charging thereof. This controller 48 may be configured, for example, to ensure that the battery 44 is not overcharged or the like.

In one embodiment, the charging system includes a charging port 50. The charging port 50 preferably comprises an interface or link between a power source and a PED. As illustrated, the charging port 50 is coupled to the battery 44 (which as indicated above is, in turn, coupled to the cells 40).

The charging port 50 may have a variety of configurations. In one preferred embodiment, the charging port 50 comprises a first contact 52 and a second contact 54 having at least a portion configured as an electrical conductor. Referring to FIG. 2, in one embodiment the first and second conductors 52,54 comprise elongate leads or wires.

The charging port 50 may be connected to the power source in various manners. In the embodiment illustrated, a first conductor, such as a wire, leads from one of the terminals of the battery 44 to the first contact 52, and a second conductor, such as a wire, leads from the other of the terminals of the battery to the second contact 54.

The charging port 50 is configured to be engaged by a PED so that power is supplied from the power supply to the PED. In one embodiment, the PED includes an interface 56 for this purpose. The interface 56 may be plugged into an appropriate charging port of the PED. The interface 56 is preferably configured to engage the first and second contacts 52,54.

In one embodiment, as illustrated in FIG. 2, the charging port 50 may be configured to be engaged by the PED automatically when the PED is located in the carrier 20. For example, in one embodiment, the first and second contacts 52,54 may be configured to extend along one or more portions of the inside of the carrier 20, such as the bottom 32 and first and second sides 28,30. When a PED such as that illustrated in FIG. 4 having an interface 56 located at a first end thereof is located in the carrier 20, the interface 56 will engage the first and second contacts 52,54 automatically.

In other embodiments, the user may be required to connect the PED to the charging port 50. For example, the charging port 50 might comprise a connector located at the end of a pair of leads extending from the battery 44. The user may be required to plug the connector into a port of the PED. The charging port 50 may have other configurations for mating with one or more other types or configurations of PED interfaces. In one embodiment, the PED need not physically contact the charging port 50. For example, the charging port 50 may be configured to generate an energy field. The PED may be configured to generate electricity from the field. For example, the PED may include an interface having a coil which, when located in the field, generates electricity which may be utilized to charge the battery of the PED.

In one embodiment, the charging system may be configured to provide an indication to a user that the PED is being charged. In one embodiment, a visible indicator may be provided. As illustrated, in FIG. 4, the visible indicator may comprise an LED 58. In one embodiment, the LED 58 is placed in the circuit with the charging port 50 and power source, such as the battery 44, whereby when the charging circuit is complete, currently flows through the LED 58, thus causing it to illuminate. When the circuit is incomplete, such as when the PED is disconnected from the charging port 50, the LED 58 ceases to illuminate because no current flows thereto.

Of course, the indicator may have other configurations. For example, the indicator may be other types of visible indicators, such as other types of lights. The indicator might even comprise a display. The indicator could alternately, or in addition, comprise an audible indicator such as a speaker configured to output audible sound, such as a tone. The indicator could also be activated in other manners.

In one embodiment, the charging system may include a controller 60 for controlling the charging process, such as by controlling the flow of electricity to the PED. The controller 60 may also provide other control functions, such as controlling the LED 58 or other visual indicator.

FIG. 3 illustrates an embodiment of the invention where certain of the components of the charging system are illustrated as located within the carrier 20. As illustrated, the battery 44 may be located in the bottom of the carrier 20, with the first and second contacts 52,54 of the charging port 50 extending upwardly along one of the sides of the carrier. Of course, the components of the charging circuit could be associated with the carrier 20 in other manners.

In one embodiment, the PED interface (and/or the charging port) may be configured to ensure that the PED can be mated with the charging port only in the correct manner. For example, the PED interface may be non-symmetrical to ensure that it can only be engaged with the charging port in one orientation (thus preventing, for example, mating in an incorrect position and potential shorting out of the battery 44 or the PED).

The charging system may have a variety of other configurations, including other components. In one embodiment, for example, the system need not include a battery, or might include more than one battery for storing power for later use in charging a PED.

In use, the cells 40 are exposed to light. This might occur when the carrier 20 is located in an office, located on the dash of a car, worn on a belt outdoors, or a variety of other instances. Upon exposure to the light, the cells 40 generate electricity which is used to charge the battery 44. The battery 44 preferably provides a DC power supply for use in charging another device, such as a PED.

A user may charge the battery(ies) of their PED by simply associating the PED with the carrier 20. The PED is associated with the charging port 50. As indicated, in a preferred embodiment, this may comprise engaging an interface 56 of the PED with contacts 52,54 of the charging port 50 when the PED is located in the carrier 20.

Once connected to the charging port, electricity is provided to the PED from the battery 44. Preferably, charging status is indicated to the user, such as via the LED 58.

In accordance with the invention, a charging source is conveniently provided for a PED. The charging source does not require a standard fixed power source such as a home or office AC outlet or a car DC outlet. Further, the power source is conveniently associated with a carrier for the PED. PEDs are commonly transported in their carriers. In accordance with the invention, when the PED is being transported or stored, it is also charged.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A charger for a portable electronic device comprising:
a carrier, said carrier comprising a body defining an interior area for housing at least a portion of said portable electronic device; and
a charging system, said charging system comprising:
at least one photovoltaic cell configured to convert light into electricity;
at least one battery configured to be charged by said electricity generated by said at least one photovoltaic cell; and
at least one charging port configured to be engaged by a portable electronic device, said charging port coupled to said at least one battery to provide electricity to said portable electronic device when said portable electronic device is engaged therewith.

2. The charger in accordance with claim 1 wherein said portable electronic device is selected from the group consisting of a cell phone, a PDA, a music player and a computer.

3. The charger in accordance with claim 1 wherein said at least one photovoltaic cell is located at an exterior of said carrier.

4. The charger in accordance with claim 1 wherein said carrier comprises a pouch having a front and back, a bottom, two opposing ends, and a flap configured to be selectively moved over an otherwise open top of said pouch.

5. The charger in accordance with claim 4 wherein said at least one photovoltaic cell is located at a front of said flap.

6. The charger in accordance with claim 1 wherein said charging port comprises a pair of contacts, said contacts separated from one another and connected to said carrier.

7. The charger in accordance with claim 1 wherein said charging system includes an indicator configured to indicate when electricity is being provided to said portable electronic device.

8. The charger in accordance with claim 7 wherein said indicator comprises a light.

9. A cell phone charging system comprising:
a cell phone carrier comprising a pouch defining an interior area for housing at least a portion of a cell phone; and
a charging system, said charging system comprising:
at least one photovoltaic cell configured to generate electricity when exposed to light;
at least one battery configured to store power generated by said at least one photovoltaic cell; and
a charging port configured to deliver power from said battery to said cell phone; said charging system associated with said pouch.

10. The cell phone charging system in accordance with claim 9 wherein said charging port comprises a least one contact for connection with a charging interface of said cell phone.

11. The cell phone charging system in accordance with claim 10 wherein said at least one contact is located in said interior area for engagement with said charging interface when said cell phone is located in said pouch.

12. The cell phone charging system in accordance with claim 9 wherein said at least one photovoltaic cell is located at an exterior of said pouch.

13. The cell phone charging system in accordance with claim 9 wherein said charging system includes an indicator configured to indicate when power is being supplied to said cell phone.

14. The cell phone charging system in accordance with claim 9 wherein said charging system includes at least one controller.

15. The cell phone charging system in accordance with claim 9 wherein said at least one photovoltaic cell comprises at least one solar cell.
